(19) United States
(12) Patent Application Publication
(10) Pub. No.: US 2012/0048411 A1
(43) Pub. Date: Mar. 1, 2012

(54) MANIFOLD VALVE AND FLUID CIRCUIT HAVING A MANIFOLD VALVE

(75) Inventors: Stephan Steyer, Gelnhausen (DE); Markus Schoeppner, Steinau (DE)

(73) Assignee: WOCO INDUSTRIETECHNIK GMBH, Bad Soden-Salmuenster (DE)

(21) Appl. No.: 13/217,180

(22) Filed: Aug. 24, 2011

(30) Foreign Application Priority Data
Aug. 24, 2010 (DE) 10 2010 037 148.3

(51) Int. Cl. F16K 11/00

(52) U.S. Cl. 137/625

(57) ABSTRACT

The present disclosure relates to a manifold valve, comprising at least one valve inlet, at least one valve outlet, at least one housing, and a first valve device rotatable around a first rotational axis arranged within the housing at least partly for opening and closing at least one connection between the valve inlet and the valve outlet, wherein at least two valve inlets and/or at least two valve outlets and at least a second valve device rotatable around a second rotational axis are arranged in the housing at least partly as well as a fluid circuit, in particular a coolant circuit.

The present application relates to a manifold valve comprising at least one valve inlet, at least one valve outlet, at least one housing, and a first valve device rotatable around a first rotational axis arranged at least partly within the housing for opening and closing at least one connection between the valve inlet and the valve outlet.

Different generic manifold valves have been disclosed in the prior art. DE 40 32 811 A1, for example, discloses a rotating valve with over-run device. A rotating piston is arranged in a case which is used to create a connection between different lines.

Furthermore, US 2007/0246109 A1 discloses a rotating valve assembly with a proposed disk-shaped valve piston arranged in a case, said piston being rotatable by means of a motor. Channels are provided in the valve piston to allow the selective connection of lines arranged in a connecting base or to close a connection between said lines.

However, the disadvantage of these manifold valves is that fluid flows in a fluid or liquid circuit can only be directed or controlled to a limited degree with only one of the respective manifold valves. In particular, said valves alone are not suitable to control the complex fluid flows, for example, in the coolant circuit of a motor vehicle, in particular an internal combustion engine of a motor vehicle in such a way that the inflow to a plurality of devices or units can be closed or opened in many different ways or a variety of combinations.

These applications require a combination of a large quantity of manifold valves known from the prior art. For example, the use of a total of five 3/2-way valves is required to control or regulate three inflows and three outflows. As a result of the use of said large quantity of 3/2-way valves, a total of 15 tube attachments need to be provided, five control lines to the respective 3/2-way valves are required, a relatively large built-up space is taken up, a heavy weight is generated and, in addition, relatively high installation expenses are incurred for integrating said control system into the fluid circuit. Another disadvantage is that the fail-safe setting cannot be ensured in case one of the 3/2-path fails, i.e., an additional valve is required for this purpose.

Therefore, an aspect of the present disclosure is to further develop the generic manifold valve in such a way that it comprises and enables the control and regulation of fluid flows within a complex fluid circuit, which in particular comprises several devices and units with a simple and cost-efficient design, in particular by reducing the number of required single valves and valve components.

According to the present disclosure, at least two valve inlets and/or at least two valve outlets and at least one second valve assembly are arranged at least part within the housing and rotatable around a second rotational axis.

It is preferable that the first rotational axis runs essentially parallel with the second rotational axis.

In the process, a manifold valve according to the present disclosure can be characterized by at least a first transmission assembly used to connect the first valve device, in particular the first rotational axis and the second valve device, in particular the second rotational axis with each other to rotate jointly, wherein a rotation of the first valve device around the first rotational axis with a first sense of rotation preferably generates a rotation of the second valve device around the second rotational axis with a second sense of rotation contrary or parallel with the first sense of rotation.

Furthermore, a manifold valve according to the present disclosure can provide at least one drive device connectable to the drive side of the first transmission device, wherein the first valve device and/or the first rotational axis is preferably comprised in the drive side of the first transmission device and the second valve device and/or the second rotational axis can be connected to the output side of the first transmission device, the second valve device and/or the second rotational axis is comprised in the drive side of the first transmission device and the first valve device and/or the first rotational axis can be connected to the drive side of the transmission or the first valve device and the second valve device and/or the first rotational axis and the second rotational axis can be connected to the output side of the first transmission device.

It is particularly preferred if the first valve device comprises at least a first valve element rotatable around the first rotational axis and/or the second valve device comprises or comprise at least a second valve element rotatable around the second rotational axis, the first valve element and/or the second valve element is or are designed at least partly as hollow part, rotary piston, cylinder, hollow cylinder, cone, truncated cone, hollow cone and/or hollow truncated cone.

For the exemplary embodiments mentioned above, it is proposed in particular that the first valve element and/or the second valve element comprises at least one connecting channel between at least one inlet opening, preferably arranged on at least one surface and at least one outlet opening in particular arranged on at least one surface.

Furthermore, a manifold valve according to the exemplary embodiments mentioned above can also be characterized by a plurality of connecting channels, a plurality of inlet openings and/or a plurality of outlet openings, wherein an inlet opening or a plurality of inlet openings is or are connected with at least two, preferably a multitude of outlet openings preferably by means of a connecting channel and/or at least two, preferably a plurality of inlet openings are connected with an outlet opening or a plurality of outlet openings.

With respect to the two alternatives mentioned above, it is particularly preferable if the valve inlet comprises the inlet opening or at least one of the inlet openings and/or the valve outlet comprises the outlet opening or at least one of the outlet openings and/or the inlet opening or one of the inlet openings of the first valve element can be connected with the valve inlet, the outlet opening or one of the outlet openings of the second valve element with the valve outlet, the outlet opening or one of the outlet openings of the first valve element with the inlet opening or one of the inlet openings of the second valve element, the inlet opening or one of the inlet openings of the second valve element with the valve inlet, the outlet opening or one of the outlet openings of the first valve element with the valve element with the valve outlet and/or the outlet opening or one of the outlet openings of the second valve element of the inlet opening or one of the inlet openings of the first valve element by means of a rotation of the first valve device and/or the second valve device depending on the first rotational position of the first valve device, in particular the first valve element and/or a second rotational position of the second valve device, in particular the second valve element.

Furthermore, the present disclosure proposes that a manifold valve can be characterized by at least two, preferably a plurality of second valve devices, wherein preferably the second rotational axes of two valve devices, preferably of all the second valve devices essentially run parallel to each other.

In the embodiment mentioned above, it is particularly preferable if at least one second transmission device preferably comprised in the first transmission device, with a first second valve device, in particular the second rotational axis of the first second valve device and a second second valve device, in particular the second rotational axis of the second second valve device, preferably all second valve devices, in particular the second rotational axes of all second valve devices are connected with each other to rotate jointly.

In doing so, it is particularly preferable if the drive side of the second transmission device is connected with the first rotational axis, the drive device and/or the drive side of the first transmission device.

Furthermore, a manifold valve according to the present disclosure can be characterized in that the inlet opening or one of the inlet openings of the first second valve element can be connected with the valve inlet, the outlet opening or one of the outlet openings of the second second valve element with the valve outlet, the valve outlet or one of the outlet openings of the first second valve element with the inlet opening or one of the inlet openings of the second second valve element, the outlet opening or one of the outlet openings of the first second valve element and/or the second second valve element with the inlet opening or one of the inlet openings of the first valve element and/or the inlet opening or one of the inlet openings of the first second valve element and/or the second second valve element with the outlet opening or one of the outlet openings of the first valve element by means of a rotation of the first second valve device depending on a third rotational position of the first second valve device, in particular the valve element of the first second valve device and/or a fourth rotational position of a second second valve device, in particular the valve element of the second second valve device.

It is particularly preferred if a manifold valve according to the present disclosure is characterized by a plurality, in particular two, three, four, five, six, eight, nine, ten, twelve or eighteen predefined first rotational positions, second rotational positions, third rotational positions and/or fourth rotational positions, wherein the predefined first, second, third and/or fourth rotational positions preferably have an equal distance between each other, are in particular offset from each other by 180°, 120°, 90°, 72°, 60°, 45°, 40°, 36°, 30° or 20° and/or a valve inlet with different valve outlets, an inlet opening of the first valve element, one of the first valve elements, the second valve element and/or one of the second valve elements with different valve inlets, an inlet opening of the first valve element, one of the first valve elements, the second valve elements and/or one of the second valve elements with different outlet openings of a different first valve element and/or second valve element, an outlet opening of the first valve element, one of the first valve elements, the second valve element and/or one of the second valve elements with different inlet openings of a different first valve element and/or second valve element, and/or an outlet opening of the first valve element, one of the first valve elements, the second valve element and/or one of the second valve elements with different valve elements can be brought into a fluidal connection and/or said fluidal connection is interruptible in at least two different first, second, third and/or fourth rotational positions.

Furthermore, a manifold valve according to the present disclosure can have a bypass line comprising at least one of the first valve device, in particular the first valve element and/or the second valve device, in particular the second valve element, wherein the bypass line provides in particular a continuous connection between at least one valve inlet and at least one valve outlet, in particular irrespectively of the first rotational position, the second rotational position, the third rotational position and/or the fourth rotational position.

Furthermore, it is proposed for the manifold valve to provide at least one, and preferably a plurality of, temperature sensor(s) arrangeable as appropriate in the region of the valve inlet, the valve outlet, the first valve device, the second valve device, the first valve element, the second valve element, the connecting channel, the inlet opening, the outlet opening, the bypass channel of the first transmission device, the second transmission device, the drive device and/or the housing, preferably for recording a temperature, in particular a fluid flowing into or through the manifold valve and/or position sensor(s), preferably for recording a position of the first valve device, the second valve device, the first valve element, the second valve element, the first transmission device, the second transmission device and/or the drive device.

Finally, a manifold valve according to the present disclosure can be characterized in that the manifold valve has a modular structure, where the housing is preferably designed with several parts, comprising in particular at least a first housing component and at least a second housing component, the first housing component preferably comprises the valve inlet and/or valve outlet at least partly and/or the second housing component comprises the valve outlet and/or valve inlet at least partly, in particular a plurality of first housing components with different geometric arrangements of the valve inlet and/or the valve outlet and/or a plurality of second housing components with different geometric arrangements of the valve outlet and/or valve inlet can be provided, a plurality of first, second and/or third valve elements, preferably comprising different geometric shapes and/or arrangements, quantity and/or geometric design of the inlet opening and/or the outlet opening can be provided, a plurality of first and/or second transmission devices, preferably comprising different transmission and/or reduction ratios can be provided, and/or at least a first valve component can be connected with at least a second valve component, preferably with a different quantity of valve components, wherein the first and the second valve component is selected from the group comprising the housing, the first housing component, the second housing component, the first valve device, the second valve device, the first valve element, the second valve element, the first transmission device, the second transmission device, the drive device, the position sensor and/or the temperature sensor.

Furthermore, the present disclosure supplies a fluid circuit, in particular a coolant circuit, preferably comprised in a motor vehicle, in particular a drive device, such as an internal combustion machine of a motor vehicle, comprising at least one manifold valve according to the present disclosure.

Consequently, the present disclosure is based on the surprising finding that by providing at least a second valve device, in particular a plurality of additional second valve devices in a housing, wherein the valve devices in particular comprise valve elements in the form of at least a rotating piston, it is possible to provide a manifold valve in a housing, said valve in particular taking over the function of a water distributor in a coolant circuit of the motor vehicle which can be used to distribute or block liquid and/or fluid media flowing in different flow directions and/or taking over the entire fluid control and/or management inside the fluid circuit, while at the same time having a simple structure, a relatively low weight and being capable of reducing the number of individual valves, in particular several manifold valves, e.g., by replacing five 3/2-way valves with one component.

Said reduction of the number of manifold valves required to control the fluid flow to one manifold valve in particular results in that the number of tube attachments can be reduced significantly, e.g., from fifteen to six, if the manifold valve, according to the present disclosure, assumes the function of five manifold valves and comprises a total of three valve inlets and three valve outlets. Furthermore, only the use and electrical connection of a single actuator is required, whereas every individual manifold valve comprises a separate actuator with a separate electrical connection when using several manifold valves.

Also, the connecting line which normally must comprise at least six wires (one ground and five trip wires) is simplified, specifically reduced to two wires, i.e., a ground and a trip wire, which in turn simplifies the signal input of a trip wire to control the manifold valve.

As a whole, said design also reduces the volume of the installation space, the weight and, at the same time, the installation expenses associated with the installation of the manifold valve into a fluid circuit thanks to the lower number of single elements.

Furthermore, it is preferably provided that the individual valve elements, in particular the rotating pistons, comprise respective toothed wheels, in particular for the formation of a first and/or second transmission device, which are interlocked to achieve an automatic rotation also of the other valve elements and rotating pistons by driving one of the rotating pistons, i.e., a forced control of all elements of the manifold valve in the different valve positions is achieved.

The provision of the respective connecting channels in the individual valve elements and rotating pistons makes it possible that the respective inlet and outlet openings of the valve elements and rotating pistons are connected to each other or a connection between them can be created in such a way that allows a fluid flow from a plurality of valve inlets to a plurality of valve outlets, in particular three valve inlets to three valve outlets. It is essentially possible to achieve any connection between the different valve outlets and the different valve inlets, depending on the position of the valve elements and rotating pistons subject to the surrounding conditions and requirements, to be able to adjust the desired fluid flows in the fluid circuit. In the process, the manifold valve can have a modular design, in particular, a manifold valve can be assembled in the fashion of a building block system, in which, for example, one or several application components, in particular different quantities of the respective individual components are selected and combined to create the manifold valve from different housing components, in particular based on the number of valve inlets and valve outlets, from different valve elements, in particular based on the desired switching combinations, from different transmission devices, in particular based on the number of different valve settings. This prevents the need to provide and store a “tailor-made” valve for the specific application.

In other words, the manifold valve according to the present disclosure combines the objectives of several valves in a single component. Depending on the complexity or construction stage of the manifold valve, i.e., subject to the quantity of rotating pistons as well as the quantity of boreholes in the rotating pistons and the resulting different valve positions, the manifold valve according to the present disclosure replaces a growing number of individual manifold valves.

Aside from the previously mentioned low installation and logistics costs resulting from the consequential component savings and the modular design and the saving of the respective drive units to operate the respective valve and the lower volume and weight of the manifold valve according to the present disclosure as well as the saving of tubing and connections, the manifold valve according to the present disclosure has the other advantages that energy uptake is only required when the valve position is changed and that no malfunctions are possible, thanks to the forced drive control of two or a plurality of valve elements, in particular rotating pistons.

Furthermore, it is possible to provide a fail-safe position of the manifold valve, in particular by creating bypass lines in the respective valve elements and rotating pistons, aimed at ensuring that predefined valve inlets with predefined valve outlets comprise a predefined bypass leak, irrespective of the position of the manifold valve. For example, openings for the bypass line can be provided around the entire circumference of the rotating piston or valve element.

The manifold valve design according to the present disclosure makes it possible to reduce the volume of the installation space, e.g., from 1.625 cm³ to 793 cm³ or 816 cm³. Consequently, the dimensions of the manifold valve with three valve inlets and outlets each on the sides of the housing can be 111 mm×110 mm×65 mm or 120 mm×110 mm×65 mm (width×depth×height). In addition, the manifold valve according to the present disclosure makes it possible that the valve inlets and the valve outlets can be arranged selectively on predefined positions on the surface of the housing, in particular selectively on a front, on a back side or on side surfaces of the housing of the manifold valve, in particular to be able to keep the respective supply lines as short as possible.

In doing so, different housing components can be supplied to provide the connections or bolts on the respective surface areas through corresponding lines in the housing components. Also, relatively small drive devices with a small construction volume and weight can be used, because a torque of, e.g., 1.5-2 Nm is sufficient.

The manifold valve according to the present disclosure can comprise a different quantity of predefined valve positions, e.g., four positions of a controller, allowing the setting of different valve positions by rotating the respective rotating pistons by defined angular distances, for example 90°, i.e., controller positions of 0°, 90°, 180°, 270° with a tolerance of, for example, +/−1°.

In the process, it is in particular pointed out that no additional position sensor in the manifold valve is required, but the position of the respective drive direction can be detected alone, because this inevitably reveals the respective position of the valve elements and the rotating pistons.

Other characteristics and advantages of the invention are outlined in the description below, in which exemplary embodiments of the invention are explained by means of schematic drawings. In the figures:

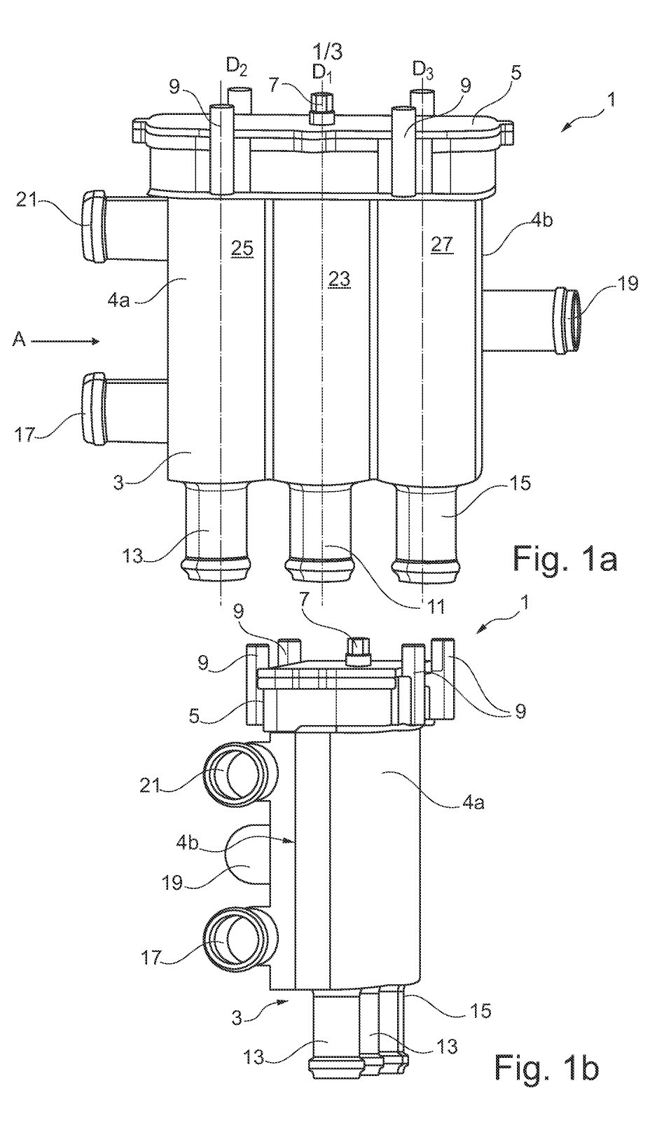

FIG. 1a shows a perspective top view of a back side of a manifold valve according to a first exemplary embodiment of the present disclosure;

FIG. 1b shows a top view from direction A in FIG. 1a;

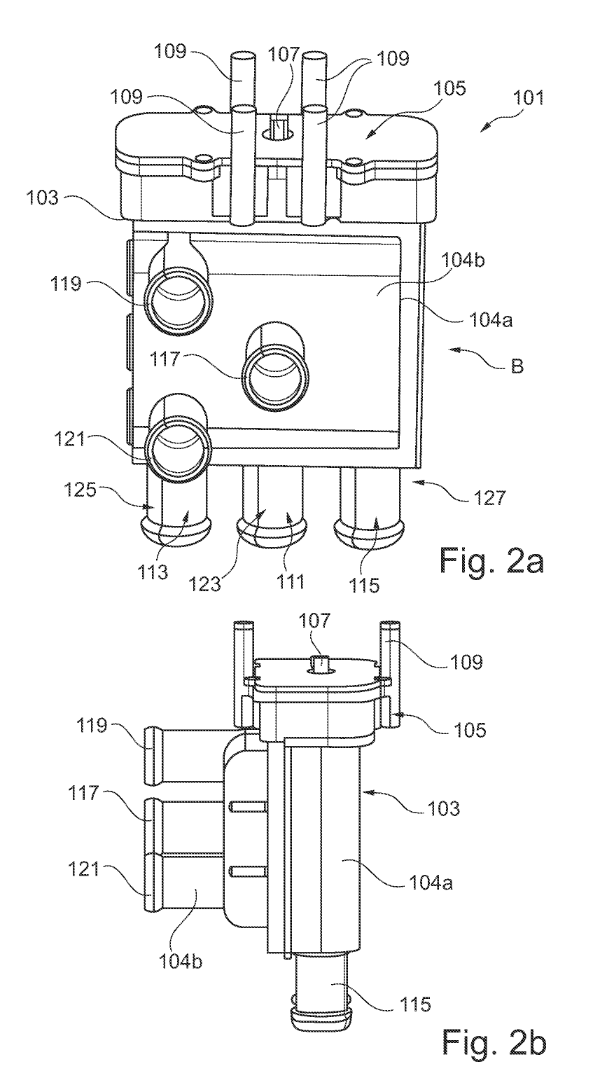

FIG. 2a shows a perspective top view of a back side of a second exemplary embodiment of the manifold valve according to the present disclosure;

FIG. 2b shows a top view of the manifold valve in FIG. 2a from direction B; and

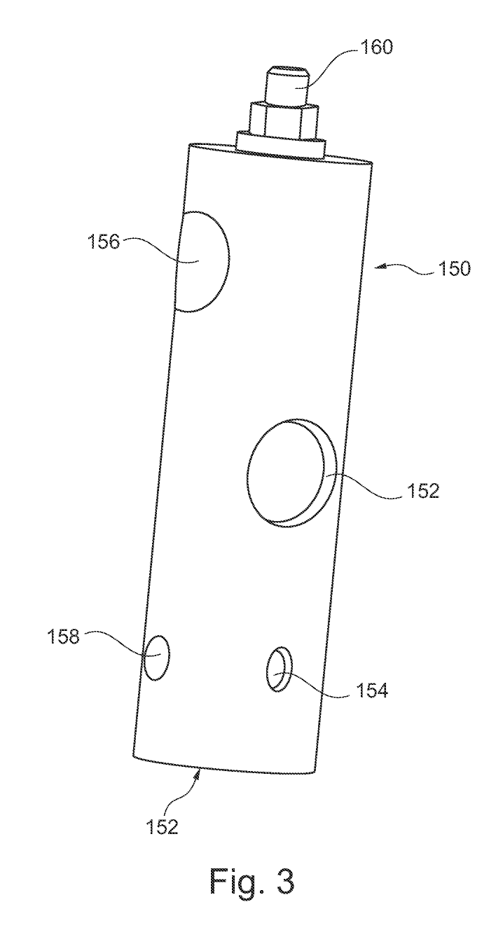

FIG. 3 shows a perspective top view of a valve element insertable into a manifold valve according to the present disclosure.

FIG. 1a shows a perspective top view of a manifold valve 1 according to the present disclosure. The manifold valve consists of a housing 3, which comprises two housing components 4a and 4b as illustrated in particular in FIG. 1b. Furthermore, a drive device 5 in the form of a toothed wheel drive is arranged in the housing 3, said toothed wheel having a drive side which can be transmitted via a drive shaft 7 by a drive with a torque, said drive in particular being attached on fastening points 9 of the housing 3. All in all, the manifold valve 1 comprises three valve inlets 11, 13, 15, as well as three valve outlets 17, 19, 21.

In manifold valve 1, the valve inlets 11, 13, 15 on the side surfaces relative to an arrangement of the transmission device 5 are arranged on a top side of the housing 3, while the valve outlets 17, 19, 21 are arranged on a front side of the housing assembly of the housing 3.

As shown in FIG. 1a and FIG. 1b, the housing component 4a comprises three housing areas 23, 25, 27. A total of three valve devices 29, 31, 33 are arranged in said housing areas 23, 25, 27, not illustrated in detail in FIG. 1, wherein the valve devices each comprise valve elements in the form of rotating pistons. Said valve elements are explained in detail later, in particular based on FIG. 3.

The respective valve elements of the valve device are rotatable around rotational axes D₁, D₂ and D₃ which run essentially parallel to each other and can be driven by means of the transmission device.

A second exemplary embodiment of a manifold valve 101 according to the present disclosure is illustrated in FIG. 2a. The elements of manifold valves 101 which correspond to those of manifold valve 1 are labeled with the same reference numbers, but increased by factor 100.

As shown in FIG. 2a, said exemplary embodiment of the manifold valve 101 according to the present disclosure provides a different arrangement of the valve outlets 117, 119, 121 compared to manifold valve 1. Indeed, the valve inlets 111, 113, 115 are arranged on the underside of the housing 103, similar to manifold valve 1, while the valve outlets 117, 119, 121 each are arranged on the front surface of the housing 103.

It can be gathered from FIG. 2b that this is achieved in that the valve outlets 117, 119, 121 each lead into interim channels which are provided as corresponding lines extending along the front side of the housing 3, more specifically the housing component 104b. As a result, the manifold valve 101 can be adjusted to the respective surrounding conditions, in particular the position of the tube connections connected with the valve outlets. For this purpose, the housing 103 has a modular design. In particular, it comprises housing components 104a and 104b. By exchanging the housing component 104b with the housing component 4b illustrated in FIG. 1, the manifold valve 101 shown in FIG. 2a and FIG. 2b can be converted into the configuration of manifold valve 1. This allows a modular design of the manifold valve and, therefore, no individual special manifold valve is required for the different forms of application, but different single elements of the manifold valve can be combined with each other to match it to the surrounding conditions and requirements. For example, it is also possible to use alternative housing elements 104a to achieve an alternative arrangement of the valve inlets 111, 113, 115 and 11, 13, 15.

Furthermore, the modular design of the manifold valve 1 or 101 continues with the design of the valve devices arranged in the housing 3 or housing 103, in particular with valve elements comprised in said valve devices. FIG. 1a illustrates that the housing 3 or the housing component 4a comprises respective subareas 23, 25, 27 in which a valve element is arranged as illustrated, for example, in FIG. 3. The valve element 150 is designed in the form of a hollow cylinder or a rotating piston and comprises a plurality of inlet openings 152, 154 and outlet openings 156, 158. In doing so, the inlet opening 152 is formed by the bottom of the hollow cylinder, while an additional inlet opening 152 is arranged on a surface area of the hollow cylinder. A corresponding outlet opening 156 is also arranged on the surface area of the hollow cylinder. The inlet opening 152, 154 as well as the outlet opening 156, 158 comprise a common connecting channel, i.e., a fluid entering through the inlet opening 152, 154 flows to the respective outlet openings 156, 158 through the connecting channel. In the process, the inlet openings 154, 152 can also assume the functions of outlet openings, while in addition the outlet openings 156, 158 can also assume the function of inlet openings, depending on the flow direction of a fluid flowing through the valve element 150.

The inlet openings 154 and the outlet opening 158 connect a bypass channel to ensure the provision of a continuous fluid flow through the valve element in different rotational positions of the valve element 150, thus to ensure a fail-safe position which prevents the complete closure of the manifold valve.

Furthermore, the valve element 150 comprises a toothed wheel 160 which is actively connected with the output side of the transmission device 5, 105. By transmitting a torque to the drive shaft 7, 107, a rotational movement is transmitted to the valve element 150 in this way.

As illustrated in FIG. 1a, the valve device, in particular the respective valve elements, are arranged in the housing 3 in such a way that their rotational axes D₁, D₂, D₃ run parallel to each other and the respective valve elements move relative to each other through a rotational movement of the drive shaft. This makes it possible to connect the respective inlet and outlet openings of the valve element 150 of the valve device 129 with inlet and outlet openings of the valve element of the adjacent valve device 31 and 33, or with the valve inlets 111, 113, 115 or the valve outlets 117, 119, 121.

In doing so, the respective valve elements are designed in such a way that a respective rotation, here, for example, by 90°, results in a different switching mode of the manifold valve.

This makes it possible to provide, for example, four switch positions of the manifold valve 1, 101. In a first position corresponding to 0° of the drive shaft 7, 107, it is possible to fluidally connect, for example, the valve inlet 15, 115 and the valve outlet 19, 119 and the valve inlet 13, 113 and the valve outlet 17, 117 through the manifold valve 113, while the valve inlet 11, 111 is closed. In a second position corresponding to 90°, the valve inlet 15, 115 can be connected with the valve outlet 17, 117, and the valve inlet 13, 113 with the valve outlet 19, 119, while the valve inlet 11, 111 continues to be closed. Here, it is in particular possible to provide that the valve outlet 21, 121 is also closed or connected with the valve inlet 15, 115 or 13, 113. In a third position corresponding to 180°, a connection between valve inlet 15, 115 and valve outlet 19, 119, between valve inlet 11, 111 and valve outlet 17, 117 as well as between valve inlet 13, 113 and valve outlet 21, 121 may exist, while in a fourth position corresponding to 270° a connection exists between valve inlet 15, 115 and valve outlet 21, 121, between valve inlet 11, 111 and valve outlet 21, 121 as well as between valve inlet 13, 113 and valve outlet 17, 117. Only the “main connections” are mentioned here, except for the continuous “bypass leak” between the valve inlet 15, 115 and the valve outlet 19, 119 secured by the bypass line, which exists irrespective of the position of the manifold valve 1, 101.

Based on the modular structure and the associated design options of the manifold valve, virtually any adjustment is possible.

For example, valve devices and valve elements can be used which comprise a greater quantity of inlet openings and outlet openings, to allow several switching positions of the manifold valve, for example a total of 12 switching positions, wherein the respective switching positions are achieved by rotating the drive shaft by 30°. Also, valve elements other than rotating pistons and hollow cylinders can be used; in particular, the valve elements can comprise several separate connecting channels.

The characteristics illustrated and described in the description above, in the claims as well as in the figures can be relevant for the invention in its different exemplary embodiments both individually as well as in any discretionary combination.

### REFERENCE NUMBERS

1 Manifold valve
3 Housing
4a Housing component
4b Housing component
5 Transmission device
7 Drive shaft
9 Fastening point
11 Valve inlet
13 Valve inlet
15 Valve inlet
17 Valve outlet
19 Valve outlet
21 Valve outlet
23, 25, 27 Housing area
29, 31, 33 Valve device
101 Manifold valve
103 Housing
104a Housing component
104b Housing component
105 Transmission device
107 Drive shaft
109 Fastening point
111 Valve inlet
113 Valve inlet
115 Valve inlet
117 Valve outlet
119 Valve outlet
121 Valve outlet
123, 125, 127 Housing area
129, 131, 133 Valve device
150 Valve element
152 Inlet opening
154 Inlet opening
156 Outlet opening
158 Outlet opening
160 Toothed wheel
A, B Direction
D₁, D₂, D₃ Rotational axis

The embodiments of the invention in which an exclusive property or privilege is claimed are defined as follows:

1. A manifold valve (1, 101) comprising at least one valve inlet (11, 13, 15, 111, 113, 115), at least one valve outlet (17, 19, 21, 117, 119, 121), at least one housing (3, 103) and a first valve device (29, 129) arranged at least partly within the housing (3, 103) and rotatable around a first rotational axis (D₁) for opening and closing at least one connection between the valve inlet (11, 13, 15, 111, 113, 115) and the valve outlet (17, 19, 21, 117, 119, 121), characterized by
at least two valve inlets (11, 13, 15, 111, 113, 115) and/or at least two valve outlets (17, 19, 21, 117, 119, 121) and at least a second valve device (31, 33, 131, 133) arranged at least partly in the housing (3, 103) and rotatable around a second rotational axis (D₂, D₃).

2. The manifold valve according to claim 1, characterized in that
the first rotational axis (D₁) essentially runs parallel to the second rotational axis (D₂, D₃).

3. The manifold valve according to claim 1, characterized by
at least a first transmission device (5, 105) with which the first valve device (29, 129), in particular the first rotational axis (D₁) and the second valve device (31, 33, 131, 133), in particular the second rotational axis (D₂, D₃) are connected to rotate jointly, wherein preferably a rotation of the first valve device (29, 129) around the first rotational axis (D₁) with a first sense of rotation results in a rotation of the second valve device (31, 33, 131, 133) around the second rotational axis (D₂, D₃) with a second sense of rotation contrary or parallel with the first sense of rotation.

4. The manifold valve according to claim 2, characterized by
at least one drive device (7, 107) connectable with the drive side of the first transmission device (5, 105), wherein
the first valve device (29, 129) and/or the first rotational axis (D₁) is/are preferably comprised in the drive side of the first transmission device (5, 105) and the second valve device (31, 33, 131, 133) and/or the second rotational axis (D₂, D₃) can be connected with the output side of the first transmission device (5, 105),
the second valve device and/or the second rotational axis is/are comprised in the drive side of the first transmission device and the first valve device and/or
the first rotational axis can be connected with the output side of the transmission or the first valve device (29, 129) and the second valve device (31, 33, 131, 133) and/or the first rotational axis (D₁) and the second rotational axis (D₂, D₃) can be connected with the output side of the first transmission device (5, 105).

5. The manifold valve according to claim 1, characterized in that
the first valve device (29, 129) comprises at least a first valve element (150) rotatable around the first rotational axis (D₁) and/or the second valve device (31, 33, 131, 133) comprises or comprise at least a second valve element rotatable around the second rotational axis (D₂, D₃), where preferably the first valve element (150) and/or the second valve element is or are designed at least partly as hollow part, rotary piston, cylinder, hollow cylinder, cone, truncated cone, hollow cone and/or hollow truncated cone.

6. The manifold valve according to claim 5, characterized in that
the first valve element (150) and/or the second valve element comprises at least one connecting channel between at least one inlet opening (152, 154), preferably arranged on at least one surface and at least one outlet opening (156, 158), in particular arranged on at least one surface.

7. The manifold valve according to claim 6, characterized by
a plurality of connecting channels, a plurality of inlet openings (152, 154) and/or a plurality of outlet openings (156, 158), wherein an inlet opening (152, 154) or a plurality of inlet openings (152, 154) is or are connected with at least two, preferably a plurality of outlet openings (156, 158) preferably by means of a connecting channel and/or at least two, preferably a plurality of inlet openings (152, 154) is or are connected with one outlet opening (156, 158) or a plurality of outlet openings (156, 158).

8. The manifold valve according to claim 6, characterized in that
the valve inlet (11, 111) comprises the inlet opening (152) or at least one of the inlet openings and/or the valve outlet comprises the outlet opening or at least one of the outlet openings and/or
the inlet opening (152) or one of the inlet openings of the first valve element (150) can be connected with the valve inlet (11, 111), the outlet opening or one of the outlet openings of the second valve element with the valve outlet (19, 21, 119, 121), the outlet opening (156, 158) or one of the outlet openings (156, 158) of the first valve element (150) with the inlet opening or one of the inlet openings of the second valve element, the inlet opening or one of the inlet openings of the second valve element with the valve inlet, the outlet opening (156, 158) or one of the outlet openings (156, 158) of the first valve element (150) with the valve outlet (17, 117) and/or the outlet opening or one of the outlet openings of the second valve element with the inlet opening (152, 154) or one of the inlet openings (152, 154) of the first valve element (150) by means of a rotation of the first valve device (29, 129) and/or the second valve device (31, 33, 131, 133) depending on a first rotational position of the first valve device (29, 129), in particular the first valve element (150), and/or a second rotational position of the second valve device (31, 33, 131, 133), in particular the second valve element.

9. The manifold valve according to claim 1, characterized by
at least two, preferably a plurality of second valve devices (31, 33, 131, 133), wherein preferably the second rotational axes (D₂, D₃) of two valve devices (31, 33, 131, 133), preferably of all second valve devices (31, 33, 131, 133) essentially run parallel to each other.

10. The manifold valve according to claim 9, characterized by
at least a second transmission device, preferably comprised in the first transmission device (5, 105), by means of which a first second valve device (31, 131), in particular the second rotational axis (D₂) of the first second valve device (31, 131), and a second second valve device (33, 133), in particular a second rotational axis (D₃) of the second second valve device (33, 133), preferably all second valve devices (31, 33, 131, 133), in particular the second rotational axes (D₂, D₃) of all second valve devices (31, 33, 131, 133) are connected with each other to rotate jointly.

11. The manifold valve according to claim 10, characterized in that
the drive side of the second transmission device is connected with the first rotational axis (D₁), the drive device (7, 107) and/or the output side of the first transmission device (5, 105).

12. The manifold valve according to claim 9, characterized in that
the inlet opening or one of the inlet openings of the first second valve element can be connected with the valve inlet (13, 113), the outlet opening or one of the outlet openings of the second second valve element with the valve outlet (19, 119), the outlet opening or one of the outlet openings of the first second valve element with the inlet opening or one of the inlet openings of the second second valve element, the outlet opening or one of the outlet openings of the first second valve element and/or the second second valve element with the inlet opening or one of the inlet openings of the first valve element and/or the inlet opening or one of the inlet openings of the first second valve element and/or the second second valve element with the outlet opening or one of the outlet openings of the first valve element by means of a rotation of a first second valve device (31, 131) depending on a third rotational position of the first second valve device (31, 131), in particular the valve element of the first second valve device (31, 131), and/or a fourth rotational position of a second second valve device (33, 133), in particular the valve element of the second second valve device (33, 133).

13. The manifold valve according to claim 1, characterized by
a plurality, in particular two, three, four, five, six, eight, nine, ten, twelve or eighteen predefined first rotational positions, second rotational positions, third rotational positions and/or fourth rotational positions, wherein the predefined first, second, third and/or fourth rotational positions preferably have an equal distance between each other, are in particular offset from each other by 180°, 120°, 90°, 72°, 60°, 45°, 40°, 36°, 30° or 20° and/or a valve inlet (11, 13, 15, 111, 113, 115) with different valve outlets (17, 19, 21, 117, 119, 121), an inlet opening (152, 154) of the first valve element (150), one of the first valve elements, the second valve element and/or one of the second valve elements with different valve inlets (11, 13, 15, 111, 113, 115), an inlet opening (152, 154) of the first valve element (150), one of the first valve elements (150), the second valve element and/or one of the second valve elements with different outlet openings of a different first valve element (150) and/or second valve element, an outlet opening of the first valve element, one of the first valve elements, the second valve element and/or one of the second valve elements with different inlet openings of a different first valve element and/or second valve element, and/or an outlet opening of the first valve element, one of the first valve elements, the second valve element and/or one of the second valve elements with different valve elements can be brought into a fluidal connection and/or said fluidal connection is interruptible in at least two different first, second, third and/or fourth rotational positions.

14. The manifold valve according to claim 13, characterized by
at least one bypass line comprised in the first valve device (29, 129), in particular the first valve element (150), and/or the second valve device (31, 33, 131, 133), in particular the second valve element, wherein in particular a continuous connection between at least one valve inlet (11, 13, 15, 111, 113, 115) and at least one valve outlet (17, 19, 21, 117, 119, 121) is provided by means of the bypass line, in particular irrespective of the first rotational position, the second rotational position, the third rotational position and/or the fourth rotational position.

15. The manifold valve according to claim 14, characterized in that
at least one, and preferably a plurality of temperature sensor(s) preferably arrangeable as appropriate in the region of the valve inlet, the valve outlet, the first valve device, the second valve device, the first valve element, the second valve element, the connecting channel, the inlet opening, the outlet opening, the bypass channel of the first transmission device, the second transmission device, the drive device and/or the housing, preferably for sensing a temperature, in particular of a fluid flowing into or through the manifold valve and/or position sensor(s), preferably for sensing a position of the first valve device, the second valve device, the first valve element, the second valve elements, the first transmission device, the second transmission device and/or the drive device.

16. The manifold valve according to claim 1, characterized in that
the manifold valve (1, 101) has a modular design, where the housing (3, 103) preferably consists of several parts, in particular at least a first housing component (4a, 104a) and at least a second housing component (4b, 104b), where the first housing component (4a, 104a) preferably comprises the valve inlet (11, 13, 15, 111, 113, 115) and/or valve outlet (17, 19, 21, 117, 119, 121) at least partly, the second housing component (4b, 104b) comprises the valve outlet (17, 19, 21, 117, 119, 121) and/or valve inlet (11, 13, 15, 111, 113, 115) at least partly, in particular a plurality of first housing components (4a, 104a) with different geometric arrangements of the valve inlet (11, 13, 15, 111, 113, 115) and/or the valve outlet (17, 19, 21, 117, 119, 121) and/or a plurality of second housing components (4b, 104b) with different geometric arrangements of the valve outlet (17, 19, 21, 117, 119, 121) and/or valve inlet (11, 13, 15, 111, 113, 115) can be provided, a plurality of first, second and/or third valve elements, preferably comprising different geometric shapes and/or arrangement, quantity and/or geometric design of the inlet opening and/or the outlet opening can be provided, a plurality of first and/or second transmission devices, preferably comprising different transmission and/or reduction ratios can be provided, and/or
at least a first valve component can be connected with at least a second valve component, preferably with a different quantity of valve components, whereby the first and the second valve component is selected from the group comprising the housing (3, 103), the first housing component (4a, 104a), the second housing component (4b, 104b), the first valve device, the second valve device, the first valve element, the second valve element, the first transmission device, the second transmission device, the drive device, the position sensor and/or the temperature sensor.

17. A fluid circuit, in particular a coolant circuit, preferably comprised in a motor vehicle, in particular a drive device, such as an internal combustion machine, of a motor vehicle, comprising at least one manifold valve according to claim 1.
